(19) United States
(12) Patent Application Publication
(10) Pub. No.: US 2025/0331611 A1
(43) Pub. Date: Oct. 30, 2025

(54) FOOTWEAR INCLUDING AN ATTACHED BLADE

(71) Applicant: Corey May, Largo, FL (US)

(72) Inventor: Corey May, Largo, FL (US)

(21) Appl. No.: 18/647,449

(22) Filed: Apr. 26, 2024

(51) Int. Cl. A43C 19/00; B26B 29/02

(52) U.S. Cl. CPC A43C 19/00; B26B 29/02

(57) ABSTRACT

A shoe including an attached blade is disclosed wherein the blade protrudes from the front portion of the shoe. The blade is bonded to the bottom surface of the shoe using an adhesive. A cover provides a safety device to allow a user to selectively conceal and expose the blade by connecting or removing the cover.

### TECHNICAL FIELD

The embodiments disclosed herein generally relate to self-defense items and more particularly to footwear having an attached knife blade.

### BACKGROUND

Knives are one of the earliest tools used by humanity and are helpful with various task and activities including cooking, hunting, combat and self-defense, etc. Commonly, knives include a blade or cutting edge which is often attached to a handle or hilt. The blade may be fixed or may fold through a pivot connecting the blade to the handle. Many configurations of knives exist allowing the user to select a suitable knife for the task at hand.

As a weapon, and particularly in self-defense situations, knives are incredibly useful as they can be easily carried and are highly concealable. Further, in most jurisdictions it is legal to carry a many types of knives, although some restrictions exist. It is common for a person to carry a knife which can be readily accessed in a self-defense situation. While effective, using a knife in a self-defense situation has inherent risks to the user.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a shoe having a blade attached thereto. The blade protrudes from the front portion of the shoe. The blade is bonded to the bottom surface of the shoe using an adhesive. A cover provides a safety device to allow a user to selectively conceal and expose the blade by connecting or removing the cover.

The embodiments provide a self-defense system which is highly inconspicuous and provides a safety device to protect from unwanted contact with the sharp edges and tip of the blade. The shoe and attached blade can be attached to various forms of footwear known in the arts such that the self-defense system can be worn in various environments. For example, blade may be attached to a boot, an athletic shoe, a dress shoe, a casual shoe, and nearly any other form of footwear known in the arts.

The blade is exposed from the front edge of the shoe, allowing the user to easily walk and otherwise wear the shoe throughout the day. The cover allows the user to selectively expose the blade, such as when they are in public or in a high-risk environment. The cover may then be attached to the blade when the user is in a safe environment to avoid unwanted contact with the sharp surfaces of the blade.

In one aspect, the blade is a diamond-shaped blade.

In one aspect, the blade includes a front portion which is comprised of a first cutting edge, a second cutting edge, and a tip.

In one aspect, the blade includes a back portion having a larger surface area than the front portion to increase the surface area over which the blade is bonded to the bottom surface of the shoe.

In one aspect, the cover is comprised of an outer surface and an interior. The interior forms a friction fit with the blade to secure the cover to the blade.

In one aspect, the outer surface includes a smooth edge to protect from unwanted contact with the first cutting edge, the second cutting edge, and the tip of the blade.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a top plan view of the shoe and blade, according to some embodiments;

FIG. 2 illustrates a bottom plan view of the shoe and blade, according to some embodiments;

FIG. 3 illustrates a top plan view of the cover separated from the blade, according to some embodiments;

FIG. 4 illustrates a top plan view of the shoe and blade having a cover attached to the blade, according to some embodiments; and

FIG. 5 illustrates a side elevation view of the shoe and blade, wherein the blade is attached to a front surface of the shoe, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate a shoe having an attached blade (which may be referred to herein as “device” or “the device”. The device is configured to be used as a self-defense tool which includes a blade attached to the toe of a shoe. This provides the user with a means of defending themselves while they still have the use of their hands. The device also provides a less-conspicuous means of carrying a blade, compared to brandishing a knife with their hands. The device is also configured to be ready to use in a threatening situation as it is attached to the shoe. It does not require the user to pull out a blade from their pocket or from knife holder (i.e., a sheath). The device may also be referred to as a “self-defense system” or a “self-defense device”.

The embodiments provide a device which increases safety for the user, as the knife blade is fixed at a position to point away from the body. This also significantly reduces the likelihood for the sharp edge(s) of the blade to contact the user's body. Further, the device makes it significantly more difficult for the attacker to take the knife from the user, as the knife is positioned at the user's feet and affixed to the user's shoe, rather than being held by in their hand.

The device comprises a blade which is attached to the bottom of the user's shoe. The device can be affixed to nearly any form of footwear which is commonly available, allowing the user to select from various style of footwear to match a preferred aesthetic. For example, the blade may be attached to boots, athletic footwear, dress footwear, casual footwear, etc.

In some embodiments, the blade is attached to the bottom of the shoe using an adhesive to bond the blade to the bottom of the shoe. The adhesive used can be various adhesives known in the arts which are able to adhere the metal blade to rubber, leather, or other common materials used in footwear construction.

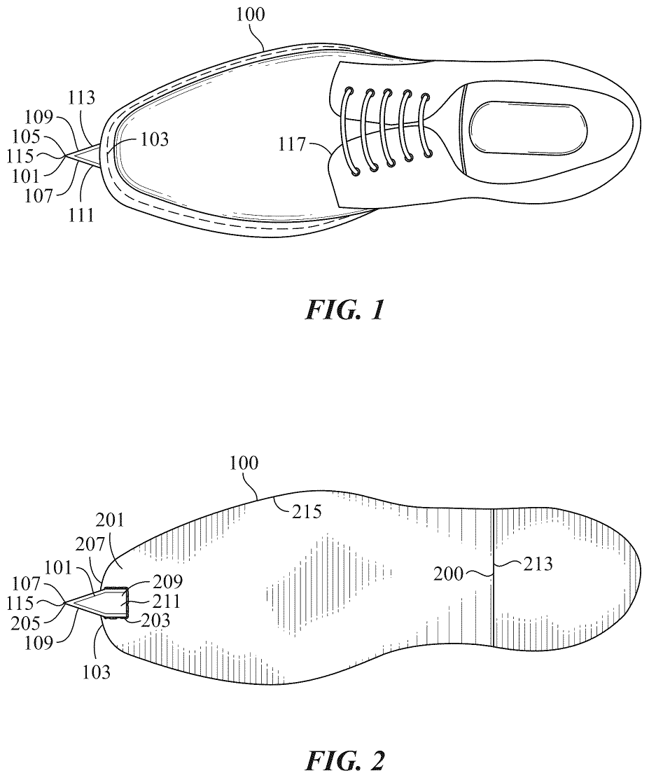

FIG. 1 illustrates the shoe 100 having a blade 101 attached to the front portion 103 of the shoe 100. The blade 101 extends from the front portion 103 of the shoe 100 and forms a diamond-shaped tip 105 having a first cutting edge 107 and a second cutting edge 109 on each side of first side 111 and the second side 113 of the blade 101. Each of the first cutting edge 107 and the second cutting edge 109 join at a tip 115 of the blade 101. The top 117 of the shoe 100 does not require any modifications, allowing for the aesthetics of the shoe 100 and ornamental design of the top 117 of the shoe 101 to be unchanged while the blade 101 is attached.

In some embodiments, the blade 101 may be attached to the left shoe, right shoe, or both shoes being worn by the user.

One skilled in the arts will readily understand that the blade 101 can take many forms and configurations and may be provided in various sizes. In one example, the blade 101 may be 1⅛-inch wide and ¼-inch thick which is suitable for being inconspicuous while being worn. Further, this size allows for the user to walk normally, without the blade causing discomfort while walking, as well as still being light enough to wear and walk for extended time periods.

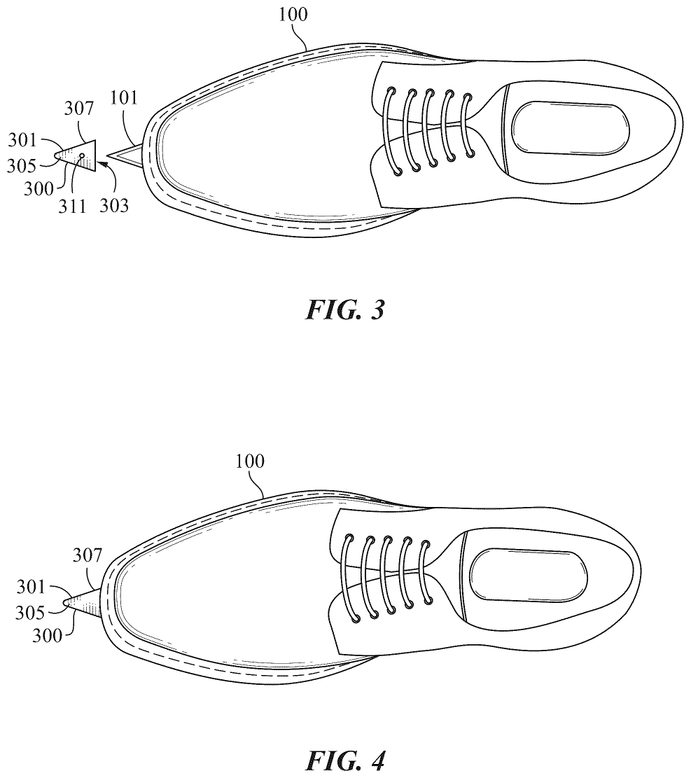

FIG. 2 illustrates the bottom 200 of the shoe 100. The blade 101 is attached to the bottom surface 201 of the shoe 100 using an adhesive 203. The adhesive 203 is applied during construction and manufacturing of the shoe 100 or may be applied by the user once the shoe 100 has been purchased. To attach the blade 101, the adhesive 203 is applied between the blade 101 and the bottom surface 201 of the shoe 100 and then pressure is applied to bond the blade 101 to the bottom surface 201. Depending on the adhesive 203 used, a curing process may be needed. This can include allowing the adhesive to dry, such as by allowing sufficient time or by applying heat. In some cases, a catalyst may be used to activate the adhesive 203.

In further reference to FIG. 2, the first end 205 of the blade 101 terminates in the tip 115 and protrudes from the front edge 207 of the shoe 100 such that the tip 115, first cutting edge 107, and second cutting edge 109 are exposed. A back portion 209 of the blade is adhered to the bottom surface 201 of the shoe 100. The adhesive 203 forms a bond between the top side of the blade 101 and the bottom surface 201 of the shoe 100. The bottom side 211 of the blade 101 is exposed from the bottom 200 of the shoe 100.

The diamond-shaped blade 101 provides some in the particular application described in the embodiments presented herein. For example, the back portion 209 has a larger surface area than the first end 205 of the blade 101. This allows for more surface area where the blade 101 can be adhered to the shoe 100, while the first end 205 remains smaller, and thus less conspicuous when protruding from the front edge 207 of the shoe 100. The larger surface area of the back portion 209 provides a stronger bond between the shoe 100 and the blade 101 to prevent the blade 101 from becoming detached from the shoe 100 during use.

In some embodiments, the back portion 209 may extend further toward the heal 213 of the shoe 100. This may provide increased surface area and a stronger bond therebetween.

In some embodiments, the blade 101 may be molded into the sole 215 of the shoe to provide a stronger connection between the blade 101 and the shoe 100.

FIG. 3 and FIG. 4 illustrate the shoe 100 and blade 101 having a cover 300 attached to the blade 100. The cover 300 is provided as a safety device 301 to cover the sharp cutting edges and tip of the blade 101. The cover 300 is removable from the blade 101 to allow the user to easily cover the blade 101 and expose the blade 101 when needed. For example, the user may selectively expose the blade 101 when in public, while re-engaging the cover to conceal the sharp edges and tip of the blade when in a safe location. The cover 300 may form a friction-fit with the blade 101 such that the cover 300 is secured when properly positioned on the blade 101. The cover 300 includes an interior 303 wherein the blade 101 is insertable. The interior 303 is dimensioned to form a friction-fit with the blade 101 to secure the cover 300 thereto. The outer surface 305 of the cover 300 provides a smooth edge 307 to provide a safe means of concealing the blade 101.

In specific reference to FIG. 4, the self-defense system is illustrated in a concealed configuration wherein the blade is covered by the cover. FIG. 3 illustrates the blade removed from the cover to expose the blade.

In some embodiments, the cover 300 is constructed of rubber which provides a smooth edge and protects from unwanted contact with the sharp edges and tip of the blade 101.

In some embodiments, the cover 300 may include at least one embedded magnet 311 such that the cover remains in a fixed position over the blade 101 when the cover 300 is attached.

In some embodiments, the blade may be constructed of any blade-making material known in the arts including stainless steel, metals, metal allows, polymers, composites, and the like.

In some embodiments, the cover 300 may be constructed of rubber, metal, wood, composite, or a similar material which is suitable for acting as a safety device.

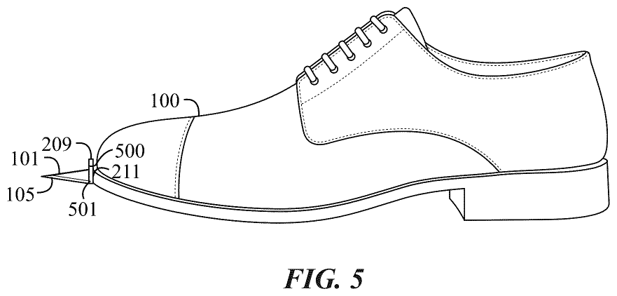

FIG. 5 illustrates the shoe 100 and blade 101, wherein the blade 101 is attached to the front surface 500 of the shoe 100. While FIGS. 1-4 illustrate the blade being adhered to the bottom of the shoe, FIG. 5 illustrates an embodiments wherein the blade 101 is adhered to the front surface 500. In this embodiment, the blade 101 has a bent portion 501 which is defined as the back portion 209 (described hereinabove). The bent portion 501 is bent at about a 90° angle with respect to the diamond-shaped tip 105, such that the bent portion 501 sufficiently contacts the front surface 500 of the shoe 100. The bent portion 501 includes the bottom side 211 (shown in FIG. 2) which is adhered using an adhesive to the front surface 500 of the shoe 100.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A shoe including an attached blade, comprising:
a shoe;
a blade protruding from a front portion of the shoe;
an adhesive to bond the blade to the front surface of the shoe; and
a cover selectively attached to the blade, the cover to provide a safety device to enable to the selective concealment and exposure of the blade.

2. The shoe including an attached blade of claim 1, wherein the blade is a diamond-shaped blade.

3. The shoe including an attached blade of claim 1, wherein the blade includes a front portion.

4. The shoe including an attached blade of claim 3, wherein the front portion is comprised of a first cutting edge, a second cutting edge, and a tip.

5. The shoe including an attached blade of claim 3, wherein the blade includes a back portion, the back portion having a larger surface area than the front portion to increase the surface area over which the blade is bonded to the bottom surface of the shoe.

6. The shoe including an attached blade of claim 1, wherein the cover is comprised of an outer surface and an interior.

7. The shoe including an attached blade of claim 6, wherein the interior forms a friction fit with the blade to secure the cover to the blade.

8. The shoe including an attached blade of claim 6, wherein the outer surface includes a smooth edge to protect from unwanted contact with the first cutting edge, the second cutting edge, and the tip of the blade.

9. A self-defense system, comprising:
a shoe;
a blade protruding from a front portion of the shoe;
an adhesive to bond a bent portion of the blade to the front surface of the shoe; and
a cover selectively attached to the blade, the cover to provide a safety device to enable to the selective concealment and exposure of the blade.

10. The self-defense system of claim 9, wherein blade is a diamond-shaped blade.

11. The self-defense system of claim 9, wherein the blade includes a front portion.

12. The self-defense system of claim 11, wherein the front portion is comprised of a first cutting edge, a second cutting edge, and a tip.

13. The self-defense system of claim 11, wherein the blade includes a larger surface area than the front portion to increase the surface area over which the blade is bonded to the bottom surface of the shoe.

14. The self-defense system of claim 9, wherein the cover is comprised of an outer surface and an interior.

15. The self-defense system of claim 14, wherein the interior forms a friction fit with the blade to secure the cover to the blade.

16. The self-defense system of claim 14, wherein the outer surface includes a smooth edge to protect from unwanted contact with the first cutting edge, the second cutting edge, and the tip of the blade.

17. The self-defense system of claim 9, wherein the blade is dimensioned having about a 1⅛-inch width at the back portion.

18. The self-defense system of claim 17, wherein the blade is about ¼-inch thick.

19. The self-defense system of claim 9, wherein the blade enables the user to walk without discomfort.

20. A shoe including an attached blade, comprising:
a shoe;
a blade protruding less than 2-inches from a front portion of the shoe;
an adhesive to bond the blade to the bottom surface of the shoe, the adhesive to bond a top surface of the blade to a sole of the shoe; and
a cover including an interior to accept the blade via a friction-fit, the cover including an outer surface having a smooth edge.
